(19) United States
(12) Patent Application Publication
(10) Pub. No.: US 2023/0275222 A1
(43) Pub. Date: Aug. 31, 2023

(54) SURFACE-TREATED ELECTRODE, PROTECTION OF SOLID ELECTROLYTES, AND ELEMENTS, MODULES AND BATTERIES COMPRISING SAID ELECTRODE

(71) Applicant: SAFT, LEVALLOIS PERRET (FR)

(72) Inventors: Christian JORDY, ST LOUIS DE MONTFERRAND (FR); Vincent PELE, BORDEAUX (FR)

(73) Assignee: SAFT, LEVALLOIS PERRET (FR)

(21) Appl. No.: 18/010,620

(22) PCT Filed: Jun. 16, 2021
(86) PCT No.: PCT/EP2021/066276

§ 371 Date: Dec. 15, 2022

(30) Foreign Application Priority Data
Jun. 16, 2020 (FR) FR2006258
Jun. 25, 2020 (FR) FR2006673

(51) Int. Cl. H01M 4/485; H01M 10/0525; H01M 10/0562; H01M 4/62

(52) U.S. Cl. CPC H01M 4/485; H01M 10/0525; H01M 10/0562; H01M 4/625; H01M 2004/027

(57) ABSTRACT

The present invention relates to an electrode covered, on all or part of its surface thereof, with a coating layer made of an electronically insulating and ionically conductive as well as the method for preparing said electrode. The present invention also relates to the protection of sulfur electrolytes in order to improve their stability with regard to moisture, in particular by means of a layer comprising an ionically conductive inorganic material comprising a halogen-type anion.

### CROSS REFERENCE TO RELATED APPLICATIONS

The present application is a U.S. National Phase Application under 35 U.S.C. § 371 of International Patent Application No. PCT.EP2021/066276 filed Jun. 16, 2021, which claims priority of French Patent Application No. 20 06673 filed Jun. 25, 2020 and French Patent Application No. 20 06258 filed Jun. 16, 2020. The entire contents of which are hereby incorporated by reference.

### FIELD OF THE INVENTION

The present invention relates to the field of energy storage, and more precisely to batteries, in particular lithium batteries.

Lithium-ion rechargeable batteries offer excellent energy and volume densities and currently occupy a prominent place in the market of portable electronics, electric and hybrid vehicles or stationary systems for energy storage.

The operation thereof is based on the reversible exchange of a lithium ion between a positive electrode and a negative electrode which are separated by an electrolyte.

The either negative or positive electrode generally consists of a conducting support used as a current collector coated with a layer containing an active material and generally, in addition, a binder and an electronic conducting material.

Moreover, solid electrolytes offer a significant improvement in terms of safety insofar same carry a much lower risk of flammability than liquid electrolytes.

More particularly, the solid sulfide electrolytes reached sufficient maturity for the industrial use thereof to be envisaged. The high ionic conductivity values thereof combined with the ductility thereof and the limited density thereof make same serious candidates for the first generations of all-solid batteries which can compete with the energy densities of current Li-ion batteries with liquid electrolytes.

However, solid electrolytes containing sulfides are at the origin of problems of deterioration of the electrodes. Highly reactive, sulfide electrolytes react with the materials forming the electrodes, in particular with the active material and the carbon material. Such deterioration of the electrodes then results in a progressive reduction in the performance of the electrochemical cell during the operation thereof.

### BACKGROUND

Hence, in order to prolong the life of electrodes, solutions for protecting the electrodes from the electrolyte need to be developed.

To overcome such a problem, it has been proposed to protect the active material of the electrode by depositing a layer of lithium oxide.

To this end, U.S. Pat. No. 9,912,014 and JP 2010/073539 teach how to cover the surface of the active material of one of the electrodes, in particular the cathode, with a thin layer of lithium niobate LiNbO₃.

However, only the active material of the electrode is protected. The other components of the electrode, in particular the electronically conducting material, are always in direct contact with the electrolyte and continue to deteriorate during the operation of the electrochemical cell.

None of the aforementioned documents teaches a solution for protecting the active material and the conducting material.

Providing an effective protection for protecting both the active material and the conducting material present in an electrode from sulfide-based electrolytic materials, still remains to be done. Moreover, a solution has to be found which does not affect the electrochemical performance of the cell.

### SUMMARY

Thus, one of the goals of the invention is to solve such issues by proposing an electrode covered, on all or part of its surface thereof, with a coating layer of an electronic insulating and ionic conducting material.

The layer of electronic insulator and ionic conductor material limits and/or prevents the reactions which are likely to occur between the electrode materials and the sulfide electrolyte, while maintaining a good electrochemical performance.

Moreover, the applicant has discovered that the presence of a layer of electronic insulator and ionic conductor material widens the accessible potential window. Applied to the surface of the positive electrode (cathode), the layer of electronic insulator and ionic conductor material lowers the value of the accessible potentials. Applied to the surface of the negative electrode (anode), the layer of electronic insulator and ionic conductor material increases the value of the accessible potentials.

The invention first relates to an electrode which can be used in an energy storage device comprising at least one active material and at least one carbon-containing electronic material, said electrode being covered, on all or part of its surface thereof, with a coating layer made of an electronic insulator and ionic conductor material, said electrode being such that A1<6 and A2>10, with:

$$A 1 = ln ( \frac{e}{σ i \times S ( mat . act . )} )$$

$$A 2 = ln ( \frac{e}{σ e \times S ( cond . )} )$$

where:
e represents the thickness of the coating layer (in m),
represents the ionic conductivity of the electronic insulator and ionic conductor material (in S·m⁻¹),
S(mat. act) represents the ratio between the surface area developed by the active material and the total surface area of the electrode (in m² of active material per cm² of electrode),
σe represents the electronic conductivity of the electronic insulator and ionic conductor material (in S·m⁻¹), and
S(cond.) represents the ratio between the surface area of active material and carbon-containing electronic material and the total surface area of the electrode (in m² per cm² of electrode).

Preferentially, said electrode is such that A1<6 and A2>10,
with:

$$A 1 = ln ( \frac{e}{σ i \times S ( mat . act . )} )$$

$$A 2 = ln ( \frac{e}{σ e \times S ( cond . )} )$$

where:
e represents the thickness of the coating layer (in m),
σi represents the ionic conductivity, measured at 25° C., of the electronic insulator and ionic conductor material (in S·m⁻¹),
S(mat. act) represents the ratio between the surface area developed by the active material and the total surface area of the electrode (in m² of active material per cm² of electrode),
e represents the electronic conductivity, measured at 25° C., of the electronic insulator and ionic conductor material (in S·m⁻¹), and
S(cond.) represents the ratio between the surface area developed by the active material and by the electronic carbon material and the total surface area of the electrode (in m² per cm² of electrode).

Preferentially, the electronic insulator and ionic conductor material has an electronic conductivity, measured at 25° C., of less than or equal to 10⁻¹⁰ S·m⁻¹, preferentially less than or equal to 10⁻¹² S·m⁻¹.

Advantageously, the electronic insulator and ionic conductor material has an ionic conductivity, measured at 25° C., greater than or equal to 10⁻⁸ S·m⁻¹, preferentially greater than or equal to 10⁻⁶ S·m⁻¹.

According to one embodiment, the electronic insulator and ionic conductor material is selected from halides, oxides, phosphates, sulfides, polymers and any one of the mixtures thereof.

Preferentially, the electronic insulator and ionic conductor material has an electronic conductivity less than or equal to 10⁻¹⁰ S·m⁻¹, preferentially less than or equal to 10⁻¹² S·m⁻¹.

Advantageously, the electronic insulator and ionic conductor material has an ionic conductivity greater than or equal to 10⁻⁸ S·m⁻¹, preferentially greater than or equal to 10⁻⁶ S·m⁻¹.

Preferentially, the electronic insulator and ionic conductor material has an electronic conductivity, measured at 25° C., of less than or equal to 10⁻¹⁰ S·m⁻¹, preferentially less than or equal to 10⁻¹² S·m⁻¹.

Advantageously, the electronic insulator and ionic conductor material has an ionic conductivity, measured at 25° C., greater than or equal to 10⁻⁸ S·m⁻¹, preferentially greater than or equal to 10⁻⁶ S·m⁻¹.

According to one embodiment, the electronic insulator and ionic conductor material is selected from halides, oxides, phosphates, sulfides, polymers and any one of the mixtures thereof.

Preferentially, the thickness of the coating layer ranges from 2 to 50 nm, preferentially from 5 to 10 nm

Advantageously, the coating layer covers at least 50% of the surface area of the electrode, preferentially at least 75%, more preferentially at least 90%, even more preferentially at least 95%.

According to a preferred embodiment, the electrode is porous and at least a portion of the pores of the electrode is at least partially filled with a solid electrolytic material, preferentially a solid electrolyte sulfur material.

According to a further preferred embodiment, the electrode coated with the coating layer is porous and at least a part of the pores of the coated electrode is at least partially filled with a solid electrolytic material, preferentially a solid, sulfur, electrolytic material.

The invention further relates to a method for manufacturing an electrode as defined hereinabove, and in detail hereinafter, the method comprising:
a) the supply of an electrode,
b) the deposition on all or part of the surface of the electrode, of a coating layer as defined hereinabove, and in detail hereinafter,
c) optionally, the deposition by infiltration into at least part of the pores, of the coating layer of a solid electrolytic material, preferentially a solid electrolyte sulfur material, and
d) optionally, a treatment enabling the electrolyte to solidify, in particular by heat treatment or by ultraviolet radiation.

The invention further relates to an electrochemical cell comprising a stack between two electronic conducting current collectors, said stack comprising:
a positive electrode;
a negative electrode;
a layer comprising a solid electrolytic composition separating said positive electrode and said negative electrode, the electrolytic composition comprising at least one solid electrolytic compound, preferentially selected from solid electrolyte sulfur compounds and polymers;

Said element being characterized in that at least one amongst said positive electrode and said negative electrode is as defined hereinabove, and in detail hereinafter.

Preferentially, in the electrochemical element according to the invention, both said positive electrode and said negative electrode are covered, over all or part of their surface thereof, with a coating layer, either identical or different, as defined hereinabove and in detail hereinafter.

The invention further relates to a method for manufacturing an electrochemical cell as defined hereinabove and in detail hereinafter, said method comprising:
i) the supply of a positive electrode and of a negative electrode, at least one amongst said positive electrode and said negative electrode being as defined hereinabove, and in detail hereinafter, or having been obtained by using the method described hereinabove, and in detail hereinafter, and
ii) the formation, between said positive electrode and said negative electrode, of a layer comprising a solid electrolytic composition.

The invention further relates to an electrochemical module comprising a stack of at least two elements as defined hereinabove, and in detail hereinafter, each element being electrically connected with one or a plurality of other elements.

Finally, the invention relates to a battery comprising one or a plurality of modules as defined hereinabove and in detail hereinafter.

### BRIEF DESCRIPTION OF THE DRAWINGS

FIG. 1 is a schematic representation of the different steps of the process for preparing an electrode according to the invention.

FIG. 2 is a schematic representation of the structure of an electrochemical element according to the invention.

FIG. 3 shows the stack of solid electrolyte particles within the layers and, with, shown magnified, the detail of the particles which are covered with a coating layer.

### DETAILED DESCRIPTION

The invention first relates to an electrode which can be used in an energy storage device, said electrode being covered, on all or part of its surface thereof, with a coating layer made of an electronic insulator and ionic conductor material.

An electrode according to the invention typically comprises a current collector on which an electrode material is deposited.

The “electrode material” as defined by the invention refers to a mixture comprising at least one active material, either cathodic or anodic depending on the nature of the electrode considered, at least one electronic carbon material and optionally a binder.

The electrode according to the invention can be either a positive electrode (also called cathode) or a negative electrode (also called anode).

The term positive electrode refers to the electrode where the electrons enter, and where the cations (Li⁺) arrive during the discharge process.

The term negative electrode refers to the electrode from which the electrons leave, and from which the cations (Li⁺) are released in discharge

Preferentially, the electrode according to the invention is a negative electrode.

Within the framework of the present invention, the positive electrode can be of any known type. The cathode typically consists of a conducting support used as a current collector on which the cathode active cathode material and an electronic carbon material are deposited. A binder can further be incorporated into the mixture.

The active cathode material is not particularly limited. Same can be selected from the following groups or the mixtures thereof:
a compound (a) with the formula LiₓM_{1-y-z-w}M′_{y}M″_{′z}M′″_{w}O₂ (LMO₂) where M, M′, M″ and M′″ are selected from the group consisting of B, Mg, Al, Si, Ca, Ti, V, Cr, Mn, Fe, Co, Ni, Cu, Zn, Y, Zr, Nb, W, and Mo provided that at least M or M′ or M″ or M′″ is selected from Mn, Co, Ni, or Fe; M, M′, M″ and M′″ being different from each other; and 0.8≤x≤1.4; 0≤y≤0.5; 0≤z≤0.5; 0≤w≤0.2 and x+y+z+w<2.1;
a compound (b) with the formula LiₓMn_{2-y-z}M′_{y}M″_{z}O₄ (LMO), where M′ and M″ are selected from the group consisting of, Mg, Al, Si, Ca, Ti, V, Cr, Fe, Co, Ni, Cu, Zn, Y, Zr, Nb, and Mo; M′ and M″ being different from each other, and 1≤x≤1.4; 0≤y≤0.6; 0≤z≤0.2;
a compound (c) with the formula LiₓFe_{1-y}M_{y}PO₄ (LFMP) where M is selected from the group consisting of B, Mg, Al, Si, Ca, Ti, V, Cr, Mn, Co, Ni, Cu, Zn, Y, Zr, Nb, and Mo; and 0.8≤x≤1.2; 0≤y≤0.6;
a compound (d) with the formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb, and Mo, with 0.8≤x≤1.2; 0≤y≤0.6; 0≤z≤0.2;
a compound (e) with the formula xLi₂MnO₃; (1−x)LiMO₂ where M is at least one element selected from Ni, Co and Mn and x≤1.
a compound (f) with formula Li₁₊ₓMO_{2-y}F_{y} with a cubic structure where M represents at least one element selected from the group consisting of Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd, and Sm and where 0≤x≤0.5 and 0≤y≤1.
a compound (g) such as LiVPO₄F (LVPF).

The current collector is preferentially a two-dimensional conducting support such as an either solid or perforated strip, containing carbon or metal, e.g. made of nickel, steel, stainless steel or aluminum, preferentially aluminum. The current collector can be coated on one or both sides with a layer of carbon.

Within the framework of the present invention, the negative electrode can be of any known type. The anode typically consists of a conducting support used as a current collector on which the active anode material and an electronic carbon material are deposited. A binder can further be incorporated into the mixture.

It is understood that in “anode free” systems, a negative electrode is present (generally limited initially to the current collector only) as well.

The active anode material is not particularly limited. Same can be selected from the following groups and the mixtures thereof:
Lithium metal or a lithium metal alloy
Graphite
Silicon
Anode-free type
a titanium dioxide and a niobium TNO having the formula:

LiₓTi_{a-y}M_{y}Nb_{b-z}M′_{z}O_{((x+4a+5b)/2)-c-d}X_{c}
where:
0≤x≤5; 0≤y≤1; 0≤z≤2; 1≤a≤5; 1≤b≤25; 0.25≤a/b≤2; 0≤c≤2 and 0≤d≤2; a-y>0; b-z>0;
M and M′ each represent at least one element selected from the group consisting of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm;
X represents at least one element selected from the group consisting of S, F, Cl and Br.

The index d represents an oxygen gap. The index d can be less than or equal to 0.5.

Said at least one titanium and niobium oxide can be selected from TiNb₂O₇, Ti₂Nb₂O₇, Ti₂Nb₂O₉ and Ti₂Nb₁₀O₂₉.
a lithium titanium oxide or a titanium oxide apt to be lithiated. Lithium titanium oxide is selected from the following oxides:
i) Liₓ₋ₐMₐTi_{y-b}M′_{b}O_{4-c-d}X_{c} wherein 0<x≤3; 1≤y≤2.5; 0≤a≤1; 0≤b≤1; 0≤c≤2 and −2.5≤d≤2.5; M represent at least one element selected from the group consisting of Na, K, Mg, Ca, B, Mn, Fe, Co, Cr, Ni, Al, Cu, Ag, Pr, Y and La;
M′ represents at least one element selected from the group consisting of B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y, and Eu;
X represents at least one element selected from the group consisting of S, F, Cl, and Br;

The index d represents an oxygen gap. The index d can be less than or equal to 0.5.
ii) HₓTi_{y}O₄ wherein 0≤x≤1; 0≤y≤2, and
iii) a mixture of the compounds i) to ii).

Examples of lithium titanium oxides belonging to group are spinel Li₄Ti₅O₁₂, Li₂TiO₃, ramsdellite Li₂Ti₃O₇, LiTi₂O₄, LiₓTi₂O₄, with 0<x≤2 and Li₂Na₂Ti₆O₁₄.

A preferred LTO compound has the formula Li₄₋ₐMₐTi_{5-b}M′_{b}O₄, e.g. Li₄Ti₅O₁₂, which is also written Li_{4/3}Ti_{5/3}O₄.

The binder present at the cathode and the anode has the function of reinforcing the cohesion between the particles of active materials and to improve the adhesion of the mixture according to the invention, to the current collector. The binder can contain one or a plurality of the following elements: polyvinylidene fluoride (PVDF) and the copolymers thereof, polytetrafluoroethylene (PTFE) and the copolymers thereof, polyacrylonitrile (PAN), poly(methyl)- or (butyl)methacrylate, polyvinyl chloride (PVC), poly(vinyl formal), polyester, block polyetheramides, acrylic acid polymers, methacrylic acid, acrylamide, itaconic acid, sulfonic acid, elastomer and cellulosic compounds. The elastomer or elastomers which can be used as a binder can be selected from styrene-butadiene (SBR), butadiene-acrylonitrile (NBR), hydrogenated butadiene-acrylonitrile (HNBR), and a mixture of a plurality thereof.

The electronic carbon material or conducting material is generally selected from graphite, carbon black, acetylene black, soot, graphene, carbon nanotubes or a mixture thereof.

The electronic carbon material is distributed throughout the active material particles and the current collector.

Current collector refers to an element such as a pad, plate, sheet or other, made of conducting material, connected to the positive or to the negative electrode, and conducting the electron flow between the electrode and the terminals of the battery.

The electrode according to the invention is covered over all or part of its surface thereof with a coating layer made of an electronic insulator and ionic conductor material.

The coating layer covers at least 50% of the surface area of the electrode, preferentially at least 75%, more preferentially at least 90%, even more preferentially at least 95%.

The thickness of the coating layer preferentially ranges from 2 to 50 nm, more preferentially from 5 to 10 nm.

In one embodiment, only the surface of the electrode material is covered by the coating layer.

Preferentially, according to such embodiment, the coating layer covers at least 50% of the surface area of the electrode, preferentially at least 75%, more preferentially at least 90%, even more preferentially at least 95%.

In one embodiment, the surface of the electrode material and at least a part of the surface of the current collector are covered by the coating layer.

Preferentially, according to such variant, at least 50% of the surface area of the collector is covered by the coating layer, more preferentially at least 75%, even more preferentially from 90% to 95%.

Thereafter in the description, and unless explicitly stated otherwise, the term “electrode” is used equivalently for naming the electrode material taken alone or else the assembly consisting of the electrode material and the current collector.

“Electronic insulator material” as defined by the invention refers to a material inapt to transport electrons. The electronic conducting behavior of a material is evaluated by measuring the electronic conductivity ae thereof.

The electronic conductivity of a material can be determined according to any method known to a person skilled in the art. Same can be measured e.g. as follows:

A pellet of the material, the electronic conductivity value of which is to be determined, is prepared by pressing the powder of said material under 5 t/cm² and then by sintering at a temperature 30% lower than the melting temperature thereof (expressed in K), for 2 h. A gold film is then deposited on the surface of the pellet, in order to improve the contact between the current collectors and the sample. The pellet is finally placed between 2 nickel collectors at the surface.

A voltage is applied across the electrodes in order to measure the evolution of the current flowing across the pellet as a function of time. The graph obtained by plotting the evolution of such current as a function of the applied voltage is a straight line the slope of which corresponds to the electronic resistance, Re, of the pellet. Finally, the electronic conductivity of the material is calculated by applying the following formula:

$$σ e = \frac{e}{S \times Re}$$

where σe is the electronic conductivity of the material (in S·m⁻¹), e represents the thickness of the pellet (in m), S is the surface area of the pellet (in m²) and Re is the electronic resistance of the material (in Ohm).

Preferentially, the electronic insulator and ionic conductor material has an electronic conductivity, measured at 25° C., less than or equal to 10⁻¹⁰ S·m⁻¹, preferentially less than or equal to 10⁻¹² S·m⁻¹.

For the purposes of the invention, the term “ionic conductor material” means a material apt to transport ions. The ionic conducting behavior of a material is evaluated by measuring the ionic conductivity σi thereof.

The ionic conductivity of a material can be determined according to any method known to a person skilled in the art. Same can be measured e.g. as follows:

A pellet of the material the ionic conductivity value of which is to be determined is prepared according to the protocol described hereinabove before being placed between 2 nickel collectors at the surface.

An impedance measurement is then carried out on the pellet on which a sinusoidal voltage of amplitude of 10 mV with different frequencies (between 1 MHz and 0.01 Hz) is applied. On the Nyquist diagram, the signal of the blocking electrodes is visible at the lowest frequencies. The intersection between the extrapolation of the signal of the blocking electrodes and the axis of the real values of the impedance R_{T} corresponds to the sum of the ionic resistance Ri and the electronic resistance Re of the pellet.

The ionic resistance R_{I} is calculated from the relationship Ri=R_{T}−Re and the ionic conductivity i is calculated by applying the following formula:

$$σ i = \frac{e}{S \times Ri}$$

where σi represents the ionic conductivity of the material (in S·m⁻¹), e represents the thickness of the pellet (in m), S is the surface area of the pellet (in m²) and Ri is the ionic resistance of the material (in Ohm).

Preferentially, the electronic insulator and ionic conductor material has an ionic conductivity, measured at 25° C., greater than or equal to 10⁻⁸ S·m⁻¹, preferentially greater than or equal to 10⁻⁶ S·m⁻¹.

The electronic insulator and ionic conductor material can be selected from azides, halides, oxides, phosphates, sulfides, polymers and any of the mixtures thereof.

When the electronic insulator and ionic conductor material is selected from azides, it is preferentially lithium azide, Li₃N.

When the electronic insulator and ionic conductor material is selected from halides, it is preferentially selected from materials with formula:
LiX, where X=F, Cl, Br or I,
Li₃MX₆, with M=Y, In, SC or a lanthanide, and X is a halogen, in particular selected from Cl, Br and I,
Li₆MX₈, with M=V, Fe, C or Ni, and X is a halogen, in particular selected from Cl, Br and I, and
Li_{2-2z}M_{1+z}X₄, with M=Zn, V, Ti, Mn, Mg, CD, Fe or Cr, 0<z<1 and X is a halogen, in particular selected from Cl, Br and I.

When the electronic insulator and ionic conductor material is selected from oxides, same is preferentially selected from metal oxides.

Metal oxides suitable for the implementation of the invention include in particular:
lithium zirconate Li₂ZrO₃,
lithium niobate LiNbO₃,
lithium titanate Li₄Ti₅O₁₂,
sodium superionic conductors (NASICON for Na Super Ionic Conductor) with the formula Na₁₊ₓZR₂SiₓP₃₋ₓO₁₂ with 0<x<3,
lithium superionic conductors (LISICON for Li Super Ionic Conductor) with the formula Li₂₊₂ₓZn₁₋ₓSiₓGeO₄ with 0<x<1,
perovskites, in particular with the formula Li_{0.33}La_{0.557}TiO₃ (LLTO),
LIPON (Li_{3.2}PO_{3.8}N_{0.2}) compounds, and
Li₃OCl anti-perovskites.

When the electronic insulator and ionic conductor material is selected from phosphates, same is preferentially selected from metal phosphates, more preferentially from metal lithium phosphates, even more preferentially from lithium thio-phosphates such as e.g. Li₁₀GEP₂S₁₂ and the derivatives thereof obtained by doping and/or substitution of one or a plurality of lithium Li or germanium Ge atoms with one or a plurality of metallic elements, in particular tin Sn.

The sulfide compounds present in the coating layer differ from the sulfide compounds present in the electrolyte composition. In particular, the sulfide compounds forming the coating layer have a higher electronic conductivity than the sulfide compounds present in the electrolyte.

When the electronic insulator and ionic conductor material is selected from sulfides, same is preferentially selected from sulfides having an electronic conductivity less than or equal to 10⁻¹⁰ S·m⁻¹.

Such sulfide compounds are selected in particular from materials with formula

[(Li₂S)_{y}(P₂S₅)_{1-y}]_{(1-z)}(LiX)_{z}
where:
X is a halogen, in particular selected from Cl, Br and I, or an oxygen atom,
0<y<1
0≤x≤1

When the electronic insulator and ionic conductor material is selected from polymers, same is preferentially selected from homopolymers and copolymers of poly(oxyethylene) (POE) or polyethylene glycol; poly(propylene) (PP); poly(propylene) carbonate (PPC); polymers such as alkyl (meth)acrylates, in particular methyl poly(meth)acrylates (PMA and PMMA); poly(meth)acrylonitrile (PAN); Polydimethylsiloxane (PDMS); cellulose and derivatives thereof, including cellulose acetates; poly(vinylidene fluoride) (PVDF); polyvinylpyrrolidone (PVP); polystyrenes sulphonate (PSS); poly(vinyl chloride) (PVC); polyethylenes, in particular poly(ethylene terephthalate) (PET); polyimides and mixtures thereof.

The copolymers which can be used include in particular copolymers such as poly(oxyethylene)-polystyrene sulfonates.

Such different polymers can comprise lithium salts such as LiTFSI, LiFSI, LiPF₆, LiClO₄. Furthermore, such polymers can contain traces or significant amounts of organic solvents, and in particular ethylene carbonate (EC), diethyl carbonate (DEC), dimethoxyethane (DME), dioxolane (DOL), etc.

There can be also an ionic liquid polymer.

Preferentially, the electronic insulator and ionic conductor material is selected from metal oxides; metal phosphates, preferentially from lithium metal phosphates; and any one of the mixtures thereof.

Advantageously, the electronic insulator and ionic conductor material is selected from lithium niobate LiNbO₃, substituted lithium phosphates, compounds such as LiPON (Li_{3.2}PO_{3.8}N_{0.2}) and any one of the mixtures thereof.

More advantageously, the electronic insulator and ionic conductor material is selected from lithium niobate LiNbO₃, compounds such LiPON (Li_{3.2}PO_{3.8}N_{0.2}) and any one of the mixtures thereof.

Advantageously, the electrode according to the invention is such that A1<6, the parameter A1 being calculated as follows:

$$A 1 = ln ( \frac{e}{σ i \times S ( mat . act . )} )$$

where:
e represents the thickness of the coating layer (in m),
σi represents the ionic conductivity, measured at 25° C., of the electronic insulator and ionic conductor material (in S·m⁻¹),
S(mat. act) represents the ratio between the surface area developed by the active material and the total surface area of the electrode (in m² of active material per cm² of electrode).

More advantageously, the electrode is such that A1≤4, preferentially A1≤1.5, more preferentially A1≤0.

Advantageously, the electrode according to the invention is such that A2>10, the parameter A2 being calculated as follows:

$$A 2 = ln ( \frac{e}{σ e \times S ( cond . )} )$$

where:
e is the thickness of the coating layer (in m),
σe is the electronic conductivity, measured at 25° C., of the electronic insulator and ionic conductor material (in S·m⁻¹), and
S(cond.) represents the ratio between the surface area developed by the active material and by the electronic carbon material and the total surface area of the electrode (in m² per cm² of electrode).

More advantageously, the electrode is such that A2≥12, preferentially A2≥13,0.

“Surface developed by a material” as defined by the invention refers to the actual surface area of the material, measured on a microscopic scale, so as to take into account any possible asperities of the material and in particular the porosity thereof. The developed surface area thus differs from the apparent surface area of the material measured at the macroscopic scale without taking into account any possible asperities.

The developed surface area of a material can be calculated from the value of the specific surface area of the material expressed in m²/kg of material.

The specific surface area of a material is typically measured by the BET method developed by Brunauer, Emett and Teller in 1938 by gas adsorption. The method is described by Alcade et al. (2013) and [is] based on the determination of the amount of gas required to coat the outer surface and inner pores of a solid with a complete monolayer of gas. The method is applicable to a solid powder sample the particle diameter of which does not exceed 2 mm and the specific surface area of which is greater than 0.2 m²·g⁻¹.

The sample is placed in an oven at 105° C., crushed and placed in a glass sample-holder. In order to empty the pores of the sample of the water and air the pores could contain, and to allow nitrogen N₂ to be attached, the sample in powder form is degassed at 105° C. for 120 minutes and cooled in a bath of liquid nitrogen to a temperature of 77 K, to prevent gas from condensing when temperature increases.

Helium, a gas which does not attach to the surface of the sample, is injected into the sample-holder for measuring the volume which is not occupied by the sample. After helium has been removed, nitrogen is injected in successive steps, thus allowing the apparatus to measure the pressure in the sample-holder. The regularly measured partial pressure can be used for determining the quantity of the nitrogen adsorbed. The results are treated using the Brunauer, Emmett and Teller equation:

$$\frac{\frac{{P}_{z}}{{P}_{a}}}{{n}_{a} ( 1 - \frac{{P}_{s}}{{P}_{0}} )} = \frac{1}{{n}_{m} C} + ( \frac{C - 1}{{n}_{m} C} ) {P}_{s} / {P}_{0}$$

wherein Ps (in Pa) is the pressure of the adsorption gas in equilibrium with the adsorbed gas, P0 (in Pa) is the saturation vapor pressure of the adsorption gas, Ps/P0 is the relative pressure of the adsorption gas, ns/P0 [−] is the relative pressure of the adsorption gas, na (in mol·g⁻¹) is the specific amount of adsorbed gas, nm (in mol·g⁻¹) is the molecular coverage capacity, the amount of adsorbed gas needed for covering a unit area with a complete monolayer, and, C is a constant (BET constant).

Graphically, the quantity

$$\frac{\frac{{P}_{z}}{{P}_{a}}}{{n}_{a} ( 1 - \frac{{P}_{s}}{{P}_{0}} )}$$

is represented as a function of the relative pressure Ps/P0. When Ps/P0 is comprised between 0.05 and 0.35, the curve has the shape of a linear function y=ax+b with:

$$a = ( \frac{C - 1}{{n}_{m} C} ) ;$$

$$b = \frac{1}{{n}_{m} C} .$$

Thus, the BET constant C is expressed as:

$$C = \frac{a}{b} + 1$$

The volume of the monolayer is given by the expression:

$${V}_{M} = \frac{1}{a + b}$$

Finally, the corresponding specific surface area As is deduced using the following relation:

$${A}_{S} = \frac{{V}_{M}}{{V}_{m} {M}_{sample}} {S}_{Adsorbate} NA$$

wherein As (in m² g⁻¹) is the specific surface area of the solid, V_{M} (in m³) is the volume of the adsorbed gas monolayer, S_{Adsorbate} (in m²) is the surface area of the effective cross section per molecule of adsorbate, Vₘ (22,414 cm³·mol⁻¹ at P=1 atm and T=25° C.) is the volume of one molecular gram, Mₛₐₘₚₗₑ (in g) is the mass of the sample after degassing, and NA [6.022×10²³ atoms·mol⁻¹] is the Avogadro constant.

The developed surface area of a sample of material is finally calculated by multiplying the specific surface area value obtained, by the mass of the sample under consideration.

The surface of the electrode is porous.

Preferentially, the electrode has a porosity greater than or equal to 30%, more preferentially greater than or equal to 40%, advantageously ranging from 40 to 60%.

Preferentially, the deposition of the coating layer does not affect the porosity of the electrode. In fact, since the coating layer has a very small thickness, the total volume of the coating is negligible with respect to the pore volume. Thus, the electrode covered with the coating layer is porous as well.

More preferentially, the electrode coated with the coating layer has a porosity greater than or equal to 25%, more preferentially greater than or equal to 40%, advantageously ranging from 40 to 60%.

According to one embodiment, at least part of the pores of the electrode, in particular the pores of the electrode coated with the coating layer, are at least partially filled with a solid electrolytic material, preferentially selected from among solid electrolytic materials which conduct lithium.

The solid electrolyte can be of any known type. The solid electrolyte is selected in particular from sulfur electrolytes, oxide type electrolytes, polymer electrolytes, polymer/ceramic hybrid electrolytes and any of the mixtures thereof.

Preferentially, the solid electrolyte is selected from sulfur electrolytes and polymers.

More preferentially, the solid electrolyte is selected from sulfur electrolytes, i.e. electrolytes comprising sulfur, more preferentially from sulfide electrolytes, alone or mixed with other constituents, such as polymers or gels. Either partially or fully crystallized sulfides as well as amorphous solids, are included. Examples of such materials can be selected from sulfides with the composition A Li₂S—B P₂S₅ (with 0<A<1.0<B<1 and A+B=1) and the derivatives thereof (e.g. with LiI, LiBr, LiCl, etc. doping); sulfides with argyrodite structure; or such as LGPS (Li₁₀GEP₂S₁₂), and the derivatives thereof. The sulfides forming the electrolytic layer differ from the sulfide compounds forming the coating layer in that same have an ionic conductivity greater than 10⁻²S·m⁻¹ and an electronic conductivity comprised between 10⁻⁸ and 10⁻¹⁰ S·m⁻¹. Electrolytic materials can also include oxysulfides, oxides (garnet, phosphate, anti-perovskite, etc.), hydrides, polymers, gels or ionic liquids conducting lithium ions.

Examples of sulfide electrolytic compositions are described in particular in Park, K. H., Bai, Q., Kim, D. H., Oh, D. Y., Zhu, Y., Mo, Y., & Jung, Y. S. (2018). Design Strategies, Practical Considerations, and New Solution Processes of Solid electrolyte sulfides for All-Solid-State Batteries. Advanced Energy Materials, 1800035.

Typically, at least 50% by volume of the pores of the electrode are filled with a solid electrolytic material, preferentially at least 70% by volume, more preferentially at least 80% by volume.

Advantageously, the coating layer and the electrolytic composition are made of distinct materials.

The further subject matter of the invention is a method for manufacturing an electrode as defined hereinabove, the method comprising:
(a) the supply of an either positive or negative electrode,
(b) the deposition, on all or part of the surface of the said electrode, of a coating layer of an electronic insulator and ionic conductor material as defined hereinabove,
(c) optionally, the deposition by infiltration into at least part of the pores of the electrode, of a solid electrolytic material as defined hereinabove, and
(d) optionally, a treatment enabling the electrolyte to solidify, preferentially by heat treatment or by ultraviolet radiation.

Preferentially, the heat treatment (optional step d) is carried out at a temperature ranging from 100° C. to 250° C.

The coating layer can be deposited on the surface of the electrode by any method known to a person skilled in the art.

Preferentially, the coating layer is deposited by atomic layer deposition (ALD), by molecular layer deposition (MLD), by chemical vapor deposition (CVD), by physical vapor deposition (PVD), by dip coating or by impregnation.

Advantageously, the coating layer is formed from a precursor composition comprising at least one precursor compound of the electronic insulator and ionic conductor material, and at least one solvent.

Preferentially, the precursor compound of the electronic insulator and ionic conductor material is selected from a source or target compound of the targeted electronic insulator and ionic conductor material or of a similar composition making it possible, under a reactive atmosphere, to obtain the desired composition profile by PVD or PLD (Deposition of LiPON from a target of Li₃PO₄ under a partial nitrogen atmosphere) or, precursors allowing the compositions targeted by ALD or MLD to be obtained.

Examples of precursor compounds which can be used in an ALD method include: lithium tert-butoxide LIO′BU, lithium hexamethyldisilazide LIN(Sime₃)₂, niobium ethanolate NB(OEt)₅, diethyl phosphoramidate H₂NP(O)(OC₂H₅)₂, trimethylphosphate.

Depending on the deposition protocol, such precursor compounds can be used with deionized water, as well as with different carrier gases (argon, e.g.) or reactive atmospheres (partial pressure of nitrogen, oxygen or ozone, e.g.).

Preferentially, the solvent is inert with respect to the compounds present in the precursor composition, in particular with respect to the precursor compound of the electronic insulator and ionic conductor material.

“Inert solvent” as defined by the invention refers to a chemical compound apt to dissolve or dilute a chemical species without reacting with same.

According to one embodiment, the method according to the invention, further comprises, after the step b), an additional step of depositing, in at least part of the pores of the electrode, in particular the pores of the electrode covered with the coating layer, a solid electrolytic material as defined hereinabove.

Advantageously, the solid electrolytic material is inserted into the pores of the electrode, in particular the pores of the electrode covered with the coating layer, by the infiltration of the electrolytic material in liquid form.

When the electrolytic material comprises a polymer, the infiltration step can be carried out before the polymerization of the material, by infiltration of a composition comprising the precursor monomers of the polymer followed by a polymerization step inside the pores, or else after the polymerization but before the crosslinking of the polymer. The infiltration step can also be carried out starting from the polymer electrolyte in the molten state.

The sulfide electrolytic materials can be introduced into the pores of the electrode, in particular of the electrode covered with the coating layer, directly in molten form or else in the form of a precursor composition prepared by dissolving the sulfide compound in a solvent.

Preferentially, when the electrolytic material is selected from sulfides, the infiltration thereof into the pores of the electrode, in particular into the pores of the electrode covered with the coating layer, is carried out by the succession of the following steps:
A) the preparation of a precursor composition by dissolving the solid electrolytic material in a solvent,
B) the impregnation of the pores of the electrode, in particular the pores of the electrode covered with the coating layer, with the precursor composition prepared during A),
C) the evaporation of the solvent, and
D) the densification of the material.

Preferentially, the solvent used for the preparation of the precursor composition is selected from organic solvents, more preferentially from ethanol, methanol, tetrahydrofuran (THF), hydrazine, water, acetonitrile, ethyl acetate, 1,2-dimethoxyethane and mixtures thereof.

The impregnation of the pores of the electrode, in particular the pores of the electrode covered with the coating layer, can be carried out by any known method. The impregnation can in particular be carried out by dip-coating the electrode in the precursor composition.

The evaporation of the solvent is typically carried out under reduced pressure and under heating. Techniques for evaporating solvents under reduced pressure are well known to a person skilled in the art who will know, depending on the solvent present in the precursor composition, how to select a suitable pressure range and a suitable temperature range.

The densification of the material is carried out by hot or cold pressing, preferentially cold pressing. Preferentially, the pressure applied is comprised between 20 and 1000 MPa, more preferentially between 300 and 800 MPa.

Examples of electrode impregnation techniques are described in particular in Dong Hyeon Kim et al., Nano Lett., 2017, 17, 5, 3013-3020; S. Yubuchi et al., J. Matter. Chem. A, 2019, 7, 558-566 and S. Yubuchi et al., Journal of Power Sources, 2019, 417, 125-131.

The invention further relates to an electrochemical cell comprising a stack between two electronic conducting current collectors, said stack comprising:
a positive electrode,
a negative electrode, and
a layer comprising a solid electrolytic composition, preferentially selected from solid sulfide electrolytes, separating said positive electrode and said negative electrode,
at least one amongst said positive electrode and said negative electrode being as defined hereinabove.

“Electrochemical cell” refers to an elementary electrochemical cell consisting of the positive electrode/electrolyte/negative electrode assembly, making it possible to store the electrical energy supplied by a chemical reaction and to restore the energy in the form of a current.

According to a first embodiment, the electrochemical element according to the invention comprises an electrode as defined hereinabove and an electrode not having a coating layer as defined hereinabove.

Preferentially, according to the first embodiment, the electrode according to the invention is the negative electrode.

According to a second embodiment, the two electrodes (the negative electrode and the positive electrode) are as defined hereinabove.

The electrochemical cells according to the invention, referred to herein as “macrobatteries”, typically have an electrical charge greater than 100 mAh. Same differ from micro-batteries and typically have a capacity greater than 0.1 Ah.

The electrochemical cell is particularly suitable for lithium batteries, such as Li-ion, primary (non-rechargeable) Li and Li—S batteries

The further subject matter of the invention is a manufacturing method for an electrochemical unit as defined hereinabove.

Preferentially, the manufacturing method of the electrochemical cell comprises the following steps:
i) the supply of a positive electrode and of a negative electrode, at least one of said positive electrode and said negative electrode being as defined hereinabove, and
ii) the formation, between said positive electrode and said negative electrode, of a layer comprising a solid electrolytic composition.

According to another subject matter, the invention further relates to an electrochemical module comprising a stack of at least two elements according to the invention, every element being electrically connected with one or a plurality of other elements, in particular via the current collectors thereof.

According to another subject matter, the present invention further relates to a battery comprising one or a plurality of modules according to the invention, and one or a plurality of cases according to the invention.

“Battery” refers to the assembly of a plurality of modules.

Said assemblies can be in series and/or parallel.

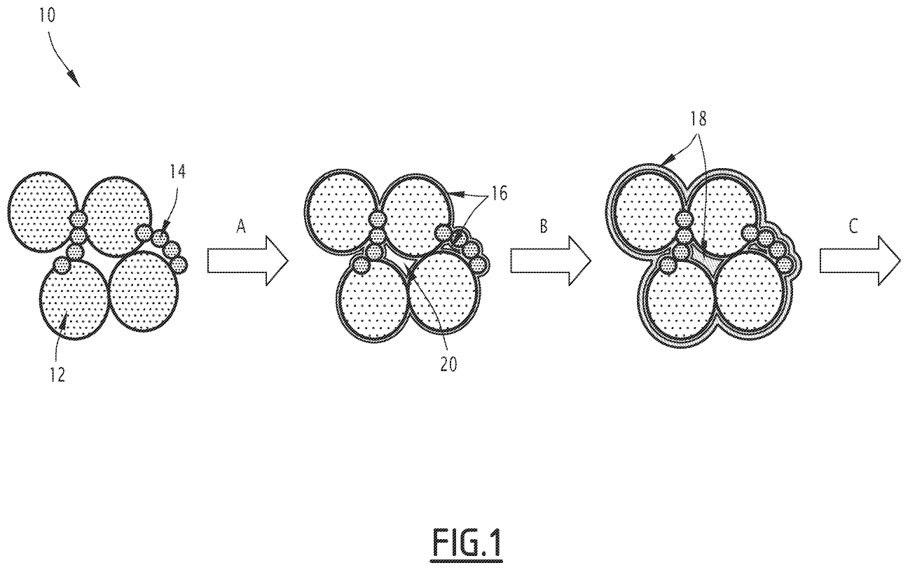

With reference to FIG. 1, the method according to the invention begins with the supply of an electrode (not shown) comprising a current collector (not shown) onto which an electrode material 10 is deposited. The electrode material 10 comprises particles of active material 12 and particles of electronic conducting carbon material 14.

During the step A, a coating layer 16 made of an electron insulator and ionic conductor material is deposited at the surface of the electrode material 10.

The step B then consists in a step of infiltration of a solid electrolyte composition 18 inside the pores 20 of the electrode material 10 and at the surface of the coating layer 16. The particles of active material 12 and the particles of electronic carbon material 14 are thus covered with two successive layers 16 and 18. The coating layer 16 is in direct contact with the particles 12 and 14, whereas the solid electrolyte layer 18 is deposited at the surface of the coating layer 16.

Finally, the step C consists of a step of drying the electrolyte composition and of compressing the material in order to obtain an electrode according to the invention.

### Examples

The examples C1 to C5 according to the invention are shown together in Tables 1 and 3. The comparative examples C1* to C4* are shown together in Tables 2 and 3.

### 1—Preparation of Positive Electrodes

The positive electrodes C1 to C14 according to the invention are prepared according to the following protocol:

1^{st} Step: Making a Porous Electrode without Solid Electrolyte

The positive electrodes are prepared by a method similar to the method used for conventional Li-ion batteries with a liquid electrolyte. The conducting carbon (a carbon black or VGCF fibers with different specific surface areas varying from 15 to 200 m²/g) is dispersed in a solvent (N-methyl-2-pyrrolidone), to which is added a binder (PVDF— polyvinylidene fluoride), and then the NMC active material with the composition: Li(Ni_{0.33}Mn_{0.33}Co_{0.33})O₂. The amount of binder is 5% and the amounts of the other constituents are given in Table 1. The amount of solvent is adjusted so that the mixture has a viscosity which makes possible, the homogeneous deposition of the ink on the aluminum current collector. After the deposition, the electrode is dried at 120° C. for 1 hour.

Calendering of the electrode is then carried out so as to reach a porosity of about 70%.

2^{nd} Step: Production of the Coating Layer

A LiNbO₃ coating layer is then deposited on the surface of the electrode obtained at the end of the step 1 by atomic layer deposition (ALD) according to a procedure adapted from the procedure described in the publication: B. Wang, Y. Zhao, M. N. Banis, Q. Sun, K. R. Adair, R. Li, T. K. Sham, X. Sun, Atomic layer deposition of lithium niobium oxides as potential solid-state electrolytes for lithium-ion batteries, ACS Appl. Mater. Interfaces, 10 (2018), pp. 1654-1661.

Successive deposition cycles are carried out on the positive electrode obtained in step 1, with lithium tert-butoxide LIO t BU and niobium ethanolate NB(OEt) 5 as precursors. The ratio between the amount of lithium ions and the amount of niobium ions deposited ranges from 2:1 to 1:4.

A plurality of successive deposition cycles is carried out in order to obtain the desired thickness and concentration. The thicknesses of the depositions are given in Tables 1 and 2.

3^{rd} Step: Insertion of the Solid Electrolyte into the Positive Electrode

The pores of the electrode are then impregnated with a Li₃PS₄ sulfide electrolyte. To this end, powders of Li₂S and P₂S₅ are dissolved in anhydrous acetonitrile in stoichiometric quantity so as to reach the Li₃PS₄ composition with a mass concentration close to 5% mass percent in the solution.

After mixing the solution for 6 hours, the porous electrode obtained at the end of the 2^{nd} step is coated by dip-coating into the solution. The electrode is then dried in a glove box and then heated under vacuum at 150° C. for 2 hours.

The electrode is then compressed under a pressure of 2t/cm².

The comparative positive electrodes C1* to C3* are prepared in a similar manner, except that:
for the comparative electrode C1*: no coating layer is deposited on the surface of the electrode,
for the comparative electrodes C2* and C3*: the LiNbO₃ coating layer is replaced by a LiLAO₂ or LLZO coating layer.

### 2—Preparation of Negative Electrodes

The same method of preparation as described hereinabove for the preparation of the positive electrodes is used for the manufacture of the negative electrode according to the invention C15, except that:
the active material is graphite powder,
the current collector is made of copper, and
the coating layer is made of LiPON.

The deposition of LiPON is carried out by atomic layer deposition (ALD) according to conditions adapted from the conditions described in the following publications:
A. C. Kozen, A. J. Pearse, C.-F. LIN, Mr. Noked, G. W. Rubloff, atomic layer deposition of the solid electrolyte LiPON, Chem. Mater., 27 (2015), pp. 5324-5331
M. Nisula, Y. Shindo, H. Koga, M. Karppinen atomic layer deposition of lithium phosphorus oxynitride, Chem. Mater., 27 (2015), pp. 6987-6993.

The comparative negative electrode C4* is prepared in a similar manner. However, no coating layer is deposited on the surface of the comparative electrode C4*.

The data relating to each of the electrodes C1 to C15 and C1* to C4* are given in Tables 1 and 2 hereinafter. The values of the electronic and ionic conductivities of the coating materials, measured according to the protocols defined hereinabove, are also reported therein, along with the values of the parameters A1 and A2, calculated for each electrode by applying the formulae given hereinabove.

The percentages are given by mass with respect to the total mass of the electrode materials.

TABLE 1

| | | | | | | | | | | |
|---|---|---|---|---|---|---|---|---|---|---|
| | | | | Carbon | | | | | | |
| | | | | specific | | σi of the | σe of the | Coated | | |
| | | | | surface | | coating | coating | layer | | |
| | Coating | Particle | % | area | % active | material | material | thickness | | |
| Electrode | material | size (μm) | carbon* | (m2/g) | material | (S.m⁻¹) | (S.m⁻¹) | (nm) | A1 | A2 |

Electrodes according to the invention

| | | | | | | | | | | | |
|---|---|---|---|---|---|---|---|---|---|---|---|
| C1 | Positive | LiNbO₃ | 2 | 2 | 50 | 93 | 3E-08 | 1E-15 | 3 | -2.5 | 13.8 |
| C2 | Positive | LiNbO₃ | 1 | 2 | 50 | 93 | 3E-08 | 1E-15 | 5 | -2.6 | 14.0 |
| C3 | Positive | LiNbO₃ | 3 | 2 | 50 | 93 | 3E-08 | 1E-15 | 10 | -0.8 | 15.1 |
| C4 | Positive | LiNbO₃ | 1 | 2 | 50 | 93 | 3E-08 | 1E-15 | 50 | -0.3 | 16.3 |
| C5 | Positive | LiNbO₃ | 0.3 | 2 | 50 | 93 | 3E-08 | 1E-15 | 5 | -3.8 | 13.1 |
| C6 | Positive | LiNbO₃ | 1 | 2 | 50 | 93 | 3E-08 | 1E-15 | 5 | -2.6 | 14.0 |
| C7 | Positive | LiNbO₃ | 5 | 2 | 50 | 93 | 3E-08 | 1E-15 | 5 | -1.0 | 14.5 |
| C8 | Positive | LiNbO₃ | 10 | 2 | 50 | 93 | 3E-08 | 1E-15 | 5 | -0.3 | 14.6 |
| C9 | Positive | LiNbO₃ | 20 | 2 | 50 | 93 | 3E-08 | 1E-15 | 5 | 0.4 | 14.7 |
| C10 | Positive | LiNbO₃ | 5 | 5 | 30 | 90 | 3E-08 | 1E-15 | 5 | -1.0 | 14.2 |
| C11 | Positive | LiNbO₃ | 5 | 10 | 15 | 85 | 3E-08 | 1E-15 | 5 | -0.9 | 14.2 |
| C12 | Positive | LiNbO₃ | 5 | 2 | 30 | 93 | 3E-08 | 1E-15 | 4 | -1.2 | 14.7 |
| C13 | Positive | LiNbO₃ | 5 | 2 | 100 | 93 | 3E-08 | 1E-15 | 5 | -1.0 | 13.9 |
| C14 | Positive | LiNbO₃ | 5 | 2 | 200 | 93 | 3E-08 | 1E-15 | 40 | 1.1 | 15.4 |
| C15 5 | Anode | LIPON | 10 | 0 | 50 | 95 | 1E-08 | 1E-12 | 100 | 3.7 | 13.0 |

*percentage of carbon in the mixture without taking into account the solid electrolyte inserted into the pores

TABLE 2

| | | | | | | | | | | |
|---|---|---|---|---|---|---|---|---|---|---|
| | | | | Carbon | | | | | | |
| | | | | specific | | σi of the | σe of the | Coated | | |
| | | | | surface | | coating | coating | layer | | |
| | Coating | Particle | | area | % active | material | material | thickness | | |
| Electrode | material | size (μm) | % carbon* | (m2/g) | material | (S.m⁻¹) | (S.m⁻¹) | (nm) | A1 | A2 |

Comparative electrodes

| | | | | | | | | | | | |
|---|---|---|---|---|---|---|---|---|---|---|---|
| C1* | Positive | — | 1 | 5 | 50 | 90 | — | — | — | — | — |
| C2* | Positive | LiLaO₂ | 1 | 2 | 50 | 93 | 1E-17 | 1E-18 | 3 | 18.7 | 20.4 |
| C3* | Positive | LLZO | 1 | 2 | 200 | 93 | 1E-03 | 1E-8 | 3 | -13.6 | -3.5 |
| C4* | Negative | — | 3 | 2 | 200 | 93 | — | — | — | — | — |

*percentage of carbon in the mixture without taking into account the solid electrolyte inserted into the pores

### 3—Producing the Battery

In a 7 mm diameter pellet mold containing an electrode disk prepared under the conditions described hereinabove, 50 mg of sulfide electrolyte with the composition (Li₃PS₄)_{0.8}(LiI)_{0.2} are added for forming the electrolytic layer for providing the electronic insulation between the 2 electrodes. The whole assembly is then compressed at 5t/cm².

After being removed from the mold, a lithium pellet with a diameter of 6 mm and a thickness of 100 μm is placed on the electrolytic layer and compressed at about 50 bar.

The assembly is then placed in a sealed electrochemical cell for the electrical connection with the 2 electrodes, while maintaining a mechanical pressure of about 50 bar.

### 4—Evaluation of the Performance of the Electrodes

The weight of the mixture in mg for the production of the electrode is equal to the desired areal capacity in mAh/cm² multiplied by the surface area of the electrode and divided by 150 mAh/g.

Each cell is then charged at C/10 up to a voltage of 4.3V if the tested electrode is a positive electrode or of 0V if the tested electrode is negative. The discharge is carried out at a rate of 10 up to a voltage of 2.5V or of 1V depending on whether the electrode is positive or negative, respectively.

The voltage difference at 1 C related to the surface coating is measured. Such difference corresponds to the voltage difference during the discharge at 1 C at a shallow depth of discharge (e.g. after 10 min) between the treated electrode and the untreated electrode and can be used for measuring the impact of the coating layer on the performance of the electrode. The value is expressed in V.

After the discharge at 1 C, the cell is then recharged at C/10 at a temperature of 60° C. and then maintained at 4.3V or 0.05V depending on whether the electrode is positive or negative, respectively. The “electrolyte decomposition current”, corresponding to the absolute value of the oxidation or the reduction current of the electrolyte depending on whether the electrode is positive or negative, is measured after a charging period of 50 hours. Same is expressed in μA per cm² of electrode.

### 5—Results

The results obtained are shown in the table hereinafter.

TABLE 3

| | |
|---|---|
| Voltage difference | Electrolyte decomposition |
| at 1 C (V) | current (μA/cm²) |

Electrodes according to the invention

| | | |
|---|---|---|
| C1 | <0.01 | 2.3 |
| C2 | <0.01 | 1.9 |
| C3 | <0.01 | 0.6 |
| C4 | <0.01 | 0.2 |
| C5 | <0.01 | 4.3 |
| C6 | <0.01 | 1.9 |
| C7 | <0.01 | 1.1 |
| C8 | <0.01 | 1.0 |
| C9 | <0.01 | 0.9 |
| C10 | <0.01 | 1.5 |
| C11 | <0.01 | 1.5 |
| C12 | <0.01 | 0.9 |
| C13 | <0.01 | 2.0 |
| C14 | <0.01 | 0.5 |
| C15 | 0.144 | 5.2 |

Comparative electrodes

| | | |
|---|---|---|
| C1* | <0.01 | >50 |
| C2* | >2 | <0.1 |
| C3* | <0.01 | >50 |
| C4* | <0.01 | >50 |

It is thus observed that the electrodes according to the invention C1 to C15 for which A1<4 and A2>10 exhibit:
a voltage difference at 1 C of less than 0.15V, and
an electrolyte decomposition current of less than 10 μA/cm².

The small voltage difference at 1 C reflects the fact that the electrochemical performance of the electrode is almost unaffected by the presence of the coating layer.

The low decomposition current demonstrates that the electrolyte is stable: the electrolyte does not react with the electrode materials.

For the comparative electrodes C1* and C4*, which do not have a coating layer, the decomposition current of the electrolyte is greater than 50 μA/cm²: The electrolyte and the materials react with each other.

Within the framework of the comparative electrode C2* for which A1=18.7, a voltage difference at 1 C greater than 2V is observed. Such high voltage difference reflects a significant alteration of the electrochemical properties of the electrode, by the LiLaO₂ coating layer.

Within the framework of the comparative electrode C3* for which A2=−3.5, it is found that the decomposition current of the electrolyte is greater than 50 μA/cm². The presence of the LLZO coating layer does not prevent reactions between the electrolyte and the electrode materials.

The present invention relates to the field of energy storage, and more precisely to batteries, in particular lithium batteries.

Lithium-ion rechargeable batteries offer excellent energy and volume densities and currently occupy a prominent place in the market of portable electronics, electric and hybrid vehicles or stationary systems for energy storage.

The operation thereof is based on the reversible exchange of a lithium ion between a positive electrode and a negative electrode which are separated by an electrolyte. Moreover, solid electrolytes offer a significant improvement in terms of safety insofar same carry a much lower risk of flammability than liquid electrolytes. Nevertheless, the electrolytes of such batteries, such as sulfide electrolytes, are often unstable.

The solid sulfide electrolytes have reached sufficient maturity for the industrial use thereof to be envisaged. The high ionic conductivity values thereof combined with the ductility thereof and the limited density thereof make same serious candidates for the first generations of all-solid batteries which can compete with the energy densities of current Li-ion batteries with liquid electrolytes.

However, such advantages are counterbalanced by the low stability of sulfides. In the presence of moisture, sulfides are likely to react and spontaneously release a toxic gas, H₂S. In addition, sulfides have limited windows of potential stability and can thus degrade when in contact with the active electrode materials with which same are associated in cells. Since such active materials are often oxides (mainly in the positive electrode), another phenomenon related to space charges can be a source of additional charging.

Hence the stability of electrolytes thus remains to be improved, while maintaining a satisfactory conductivity and energy densities, in order to accelerate the progress of all-solid technologies so that the industrialization thereof can be envisaged with limited safety risks.

U.S. Pat. No. 2017/0331149 describes a solid sulfide electrolyte covered with an oxide phase resulting from the oxidation of the sulfur material, at the surface of the sulfur material.

WO2014/201568 relates to lithium-sulfur electrochemical cells, the solid electrolyte of which comprises at least a lithium salt and a polymer but does not envisage a protective layer for the electrolyte particles.

CN109244547 describes a solid electrolytic separator such that the electrolyte powder is coated with an oxide layer. Nevertheless, the coatings envisaged are not compatible with wide windows of stability, both at the positive electrode and the negative electrode.

U.S. Pat. No. 8,951,678 describes a solid electrolyte comprising a sulfide electrolyte and a film for coating the electrolyte based on a water-tight polymer. However, since such polymer does not contain lithium salt, the polymer cannot conduct lithium in a battery which does not contain any liquid electrolyte; the salt of the latter will diffuse into the polymer to make same an ionic conductor.

It is thus desirable to provide a protection of solid sulfide electrolytes, which would prevent the secondary reaction of the solid electrolyte, while maintaining the required ionic conductivity of the particles.

According to a first subject matter, the present application relates to electrolyte particles to be used in an electrochemical cell, characterized in that said particles consist of solid sulfide electrolyte particles coated with a layer comprising an ionic conducting inorganic material comprising a halogen.

According to one embodiment, the coating material is not an oxide.

According to one embodiment, the coating layer consists exclusively of the coating material.

According to one embodiment, the coating material can comprise a plurality of anions, with the proviso that the anions are predominantly (in moles) one or a plurality of halogens.

According to one embodiment, said coating material has the formula (I):

Li₃₊ₐY_{1+b}M_{c}X_{6+d} (I)
Wherein:
Y represents yttrium;
M is a metal selected from Zr, Hf, Ti, Si, B, Al, Sc, Ga, Ta, Nb, Ca, Mg;
X represents a halogen atom selected from Cl, Br, I, F;
a, b, c and d, which are either identical or different, are numbers, the absolute value of which is comprised between 0 and 0.5 (limits included) and such that: a+3xb+nxc=d;
n is an integer equal to 2, 3, 4 or 5, depending on the nature of M:
n=2 for Ca, Mg; n=3 for B, Al, Sc, Ga; n=4 for Si, Zr, Ti, Hf and n=5 for Nb, Ta.

According to one embodiment, the coating material has the formula (II

(Li₃₊ₐY_{1+b}M¹_{c}X¹_{6+d})_{[1/(10+a+b+c+d)-x]}(AᵤM²ᵥO_{w}S_{y}N_{z}X²ₜ)ₓ (II)
Wherein:
Y represents yttrium;
M¹ is a metal selected from Zr, Hf, Ti, Si, B, Al, Sc, Ga, Ta, Nb, Ca, Mg;
X¹ and X², which can be the same or different, independently represent a halogen atom selected from Cl, Br, I, F;
a, b, c and d, which are either identical or different, are numbers the absolute value of which is comprised between 0 and 0.5 (limits included) and such that: a+3xb+nxc=d;
n is an integer equal to 2, 3, 4 or 5, depending on the nature of M:
n=2 for Ca, Mg; n=3 for B, Al, Sc, Ga; n=4 for Si, Zr, Ti, Hf and n=5 for Nb, Ta; A=Li, Na, K, Mg, Ca;
M² is an element selected from Si, B, Al, SC, GA, TA, NB, P, a transition metal (MT), a rare earth (TR);
u, v, w, x, y, z, t either identical or different are such that:

u+v+w+y+z+t=1;
u: number between 0 and 0.6 (limits included);
v: number between 0.1 and 0.3 (limits included);
w, y, z, t: numbers between 0 and 0.6 (limits included); and x: number between 0 and 0.3 (limits included).

Preferentially, the following special definitions applicable to formulae (I) and/or (II) hereinabove can be mentioned, with the proviso that the special definitions can be taken individually together with the other definitions mentioned hereinabove, or according to each of the combinations thereof:
in the general formula (I), X is Cl or Br; and/or
in the general formula (II), X¹ and X², either identical or different, are selected from Cl or Br;
b is equal to about 0; and/or
c is equal to about 0; and/or
d is equal to about 0.

The solid particles can be coated over all or a part of the peripheral surface thereof. According to one embodiment, same are coated over the entire peripheral surface thereof. The coating layer covers at least 50% of the specific surface area of the particles, preferentially at least 75%, more preferentially at least 90%, even more preferentially at least 95%.

According to the invention, the solid electrolyte particles are of the “sulfur” particles, i.e. comprising sulfur.

The electrolyte particles can be either identical or different, (i.e.) corresponding to one or a plurality of electrolytic constituents, with the proviso that at least one electrolyte contains sulfur.

Said electrolytes can be mixed with other constituents, such as polymers or gels.

Either partially or fully crystallized sulfides as well as amorphous solids, are included. Examples of such materials can be selected from sulfides with the composition y(Li₂S)−(1−y)(P₂S₅) (with 0<y<1) and the derivatives thereof (e.g. with LiI, LiBr, LiCl, etc. doping); sulfides with argyrodite structure; or LGPS (Li₁₀GeP₂S₁₂), and the derivatives thereof. Electrolytic materials can also include oxysulfides, oxides (garnet, phosphate, anti-perovskite, etc.), hydrides, polymers, gels or ionic liquids conducting lithium ions.

Examples of sulfide electrolytic compositions are described in particular in Park, K. H., Bai, Q., Kim, D. H., Oh, D. Y., Zhu, Y., Mo, Y., & Jung, Y. S. (2018). Design Strategies, Practical Considerations, and New Solution Processes of Solid electrolyte sulfides for All-Solid-State Batteries. Advanced Energy Materials, 1800035.

Sulfide electrolytes include in particular:
Li₃PS₄,
all [(Li₂S)_{y}(P₂S₅)_{1-y}]_{(1-z)} (LiX)_{z} (with X representing a halogen element; 0<y<1;
0<z<1) phases
(Li₃PS₄)_{0.8}(LiI)_{0.2},
argyrodites such as Li₆PS₅X, with X=Cl, Br, I, or Li₇P₃S₁₁,
sulfide electrolytes having the crystallographic structure equivalent similar to the structure of Li₁₀GeP₂S₁₂, and
mixtures thereof.

According to one embodiment, the layer has a thickness of less than 20 nm, in particular less than 10 nm, more preferentially from 2 to 5 nm.

According to another subject matter, the present invention further relates to a method for preparing coated solid electrolyte particles according to the invention, said method comprising the deposition of said layer of material on said particles.

According to one embodiment, the application can be carried out by any method for depositing of thin film, such as:
chemical deposition: sol-gel, spin coating, vapor phase deposition, atomic layer deposition (ALD), molecular layer deposition (MLD), or by controlled oxidation; and
Physical vapor deposition (PVD): vacuum evaporation, sputtering, pulsed laser deposition, electrohydrodynamic deposition.

Typically, the layer can be deposited by ALD or PVD, in particular by magnetron sputtering.

ALD consists in successively exposing the surface of particles to different chemical precursors so as to obtain ultra-thin layers.

Typically, the treatment by PVD is carried out using a method allowing particles to move, such as the fluidized bed or “barrel sputtering” for producing a more homogeneous deposition on the surface of the particles.

The deposition can in particular be carried out by application or adaptation of the deposition conditions described by Fernandes et al., Surface and coatings technology 176 (2003), 103-108.

The powders of the material to be deposited can be prepared by mechanosynthesis, from precursors in stoichiometric quantity which are then ground.

According to another subject matter, the invention further relates to an all-solid electrochemical element comprising electrolyte particles according to the invention.

“Electrochemical cell” refers to an elementary electrochemical cell consisting of the positive electrode/electrolyte/negative electrode assembly, making it possible to store the electrical energy supplied by a chemical reaction and to restore the energy in the form of a current.

In elements of the all-solid type, the electrolytic compounds can be included in the electrolytic layer but can also be included in part within the electrodes.

An all-solid element according to the invention thus consists of a negative electrode layer, a positive electrode layer and an electrolytic separating layer, such that the electrolyte particles according to the invention are present within at least one of the three layers.

It is understood that either identical or different electrolyte particles can be present within the three layers respectively, with the proviso that coated electrolyte particles according to the invention are present, preferentially within the electrolytic layer.

The electrochemical cell according to the invention is particularly suitable for lithium batteries, such as Li-ion, Li primary (non-rechargeable) and Li—S batteries. Such materials can be further used in Na-ion, K-ion, Mg-ion or Ca-ion batteries.

The negative electrode layer typically consists of a conducting support used as a current collector on which the negative electrode material is deposited, comprising a negative electrode active material to which solid electrolyte particles can be added, and an electronic conductor material. A binder can further be incorporated into the mixture.

The term “negative electrode” refers to the electrode working as anode, when the battery is in discharge, and to the electrode working as a cathode when the battery is in charge, the anode being defined as the electrode where an electrochemical oxidation reaction (electron emission) takes place, while the cathode is the seat of the reduction.

Within the framework of the present invention, the negative electrode can be of any known type.

It is understood that in systems without an anode called “anode free”, a negative electrode is also present (generally limited initially to the current collector only).

The active material of the negative electrode is not particularly limited. Same can be selected from the following groups and the mixtures thereof:
Lithium metal or a lithium metal alloy
Graphite
Silicon
Without anode (anode-free)
a titanium and niobium oxide TNO having the formula:

LiₓTi_{a-y}M_{y}Nb_{b-z}M′_{z}O_{((x+4a+5b)/2)-c-d}X_{c}
where 0≤x≤5; 0≤y≤1; 0≤z≤2; 1≤a≤5; 1≤b≤25; 0.25≤a/b≤2; 0≤c≤2 and 0≤d≤2; a-y>0; b-z>0;
M and M′ each represent at least one element selected from the group consisting of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm;
X represents at least one element selected from the group consisting of S, F, Cl, and Br.

The index d represents an oxygen gap. The index d can be less than or equal to 0.5.

Said at least one titanium and niobium oxide can be selected from TiNb₂O₇, Ti₂Nb₂O₇, Ti₂Nb₂O₉ and Ti₂Nb₁₀O₂₉.
a lithium titanium oxide or a titanium oxide apt to be lithiated. Lithium titanium oxide is selected from the following oxides:
i) Liₓ₋ₐMₐTi_{y-b}M′_{b}O_{4-c-d}X_{c} wherein 0<x≤3; 1≤y≤2.5; 0≤a≤1; 0≤b≤1; 0≤c≤2 and −2.5≤d≤2.5;
M represents at least one element selected from the group consisting of Na, K, Mg, Ca, B, Mn, Fe, Co, Cr, Ni, Al, Cu, Ag, Pr, Y, and La;
M′ represents at least one element selected from the group consisting of B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y, and Eu;
X represents at least one element selected from the group consisting of S, F, Cl, and Br;
The index d represents an oxygen gap. The index d can be less than or equal to 0.5.
ii) HₓTi_{y}O₄ wherein 0≤x≤1; 0≤y≤2, and
iii) a mixture of the compounds i) to ii).

Examples of lithium titanium oxides belonging to group i) are spinel Li₄Ti₅O₁₂, Li₂TiO₃, ramsdellite Li₂Ti₃O₇, LiTi₂O₄, LiₓTi₂O₄, with 0<x≤2 and Li₂Na₂Ti₆O₁₄.

A preferred LTO compound has the formula Li₄₋ₐMₐTi_{5-b}M′_{b}O₄, e.g. Li₄Ti₅O₁₂, which is also written Li_{4/3}Ti_{5/3}O₄.

The positive electrode layer typically consists of a conducting support used as a current collector on which the positive electrode material is deposited comprising, in addition to the solid electrolyte particles, a positive electrode active material and a electronic conductor carbon material. A binder can further be incorporated into the mixture.

This carbon additive is distributed across the electrode so as to form an electronic percolating network between all the particles of active material and the current collector.

When the battery is in discharge, the term “positive electrode” refers to the electrode acting as a cathode and, when the battery is charging, to the electrode acting as an anode.

Within the framework of the present invention, the positive electrode can be of any known type.

The active material of the positive electrode is not particularly limited. Same can be selected from the following groups or the mixtures thereof:
a compound (a) with the formula LiₓM_{1-y-z-w}M′_{y}M″_{z}M′″_{w}O₂ (LMO₂) where M, M′, M″ and M′″ are selected from the group consisting of B, Mg, Al, Si, Ca, Ti, V, Cr, Mn, Fe, Co, Ni, Cu, Zn, Y, Zr, Nb, W, and Mo provided that at least M or M′ or M″ or M′″ is selected from Mn, Co, Ni, or Fe; M, M′, M″ and M′″ being different from each other; and 0.8≤x≤1.4; 0≤y≤0.5; 0≤z≤0.5; 0≤w≤0.2 and x+y+z+w<2.1;
a compound (b) with the formula LiₓMn_{2-y-z}M′_{y}M″_{z}O₄ (LMO), where M′ and M″ are selected from the group consisting of, Mg, Al, Si, Ca, Ti, V, Cr, Fe, Co, Ni, Cu, Zn, Y, Zr, Nb, and Mo; M′ and M″ being different from each other, and 1≤x≤1.4; 0≤y≤0.6; 0≤z≤0.2;
a compound (c) with the formula LiₓFe_{1-y}M_{y}PO₄ (LFMP) where M is selected from the group consisting of B, Mg, Al, Si, Ca, Ti, V, Cr, Mn, Co, Ni, Cu, Zn, Y, Zr, Nb, and Mo; and 0.8≤x≤1.2; 0≤y≤0.6;
a compound (d) with the formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb, and Mo, with 0.8≤x≤1.2; 0≤y≤0.6; 0≤z≤0.2;
a compound (e) with the formula XLi₂MnO₃; (1-x)LiMO₂ where M is at least one element selected from Ni, Co and Mn and x≤1.
a compound (f) with formula Li₁₊ₓMO_{2-y}F_{y} with a cubic structure where M represents at least one element selected from the group consisting of Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd, and Sm and where 0≤x≤0.5 and 0≤y≤1;
a compound (g) such as LiVPO₄F (LVPF)

The function of the binder present at the positive electrode and at the negative electrode is to reinforce the cohesion between the particles of active materials and to improve the adhesion of the mixture according to the invention to the current collector. The binder can contain one or a plurality of the following elements: polyvinylidene fluoride (PVDF) and the copolymers thereof, polytetrafluoroethylene (PTFE) and the copolymers thereof, polyacrylonitrile (PAN), poly(methyl)- or (butyl)methacrylate, polyvinyl chloride (PVC), poly(vinyl formal), polyester, block polyetheramides, acrylic acid polymers, methacrylic acid, acrylamide, itaconic acid, sulfonic acid, elastomer and cellulosic compounds. The elastomer or elastomers which can be used as a binder can be selected from styrene-butadiene (SBR), butadiene-acrylonitrile (NBR), hydrogenated butadiene-acrylonitrile (HNBR), and a mixture of a plurality thereof.

The electronic conductor material is generally selected from graphite, carbon black, acetylene black, soot, graphene, carbon nanotubes or a mixture thereof.

Current collector refers to an element such as a pad, plate, sheet or the other, made of conducting material, connected to the positive or to the negative electrode, and conducting the electron flow between the electrode and the terminals of the battery. The current collector is preferentially a two-dimensional conducting support such as an either solid or perforated strip, containing metal, e.g. nickel, steel, stainless steel or aluminum.

According to another subject matter, the present invention further relates to an electrochemical module comprising a stack of at least two elements according to the invention, each element being electrically connected with one or a plurality of other elements.

The term “module” thus refers herein to the assembly of several electrochemical elements, said assemblies possibly being in series and/or parallel.

According to another of said subject matters, the invention further relates to a battery comprising one or a plurality of modules according to the invention.

“Battery” refers to the assembly of a plurality of modules according to the invention. The invention preferentially relates to batteries of which capacity is greater than 100 mAh, typically 1 to 100 Ah.

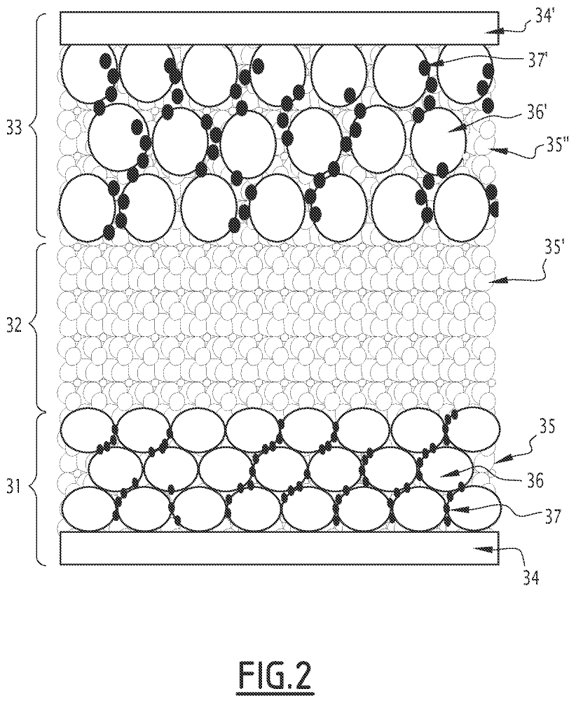

With respect to FIG. 2, the element comprises a negative electrode layer (31), a positive electrode layer (33), separated by an electrolytic layer (32).

The negative electrode layer (31) comprises a current collector (34) on which the negative electrode material according to the invention is deposited, consisting of solid electrolyte particles (35), of negative electrode active material (36), and of carbon particles (37). The separation layer (32) consists of solid electrolyte particles (35′). The particles (35′) can be identical to the particles (35).

The positive electrode layer (33) comprises a current collector (34′) on which a mixture is deposited comprising solid electrolyte particles (35″), conducting carbon (37′), and active material particles (36′).

It is understood that the layers (31) and (33) can further comprise binders, which are not shown in FIG. 2.

According to the invention, the solid electrolyte particles (35), (35′) and/or (35″) comprise particles coated according to the invention.

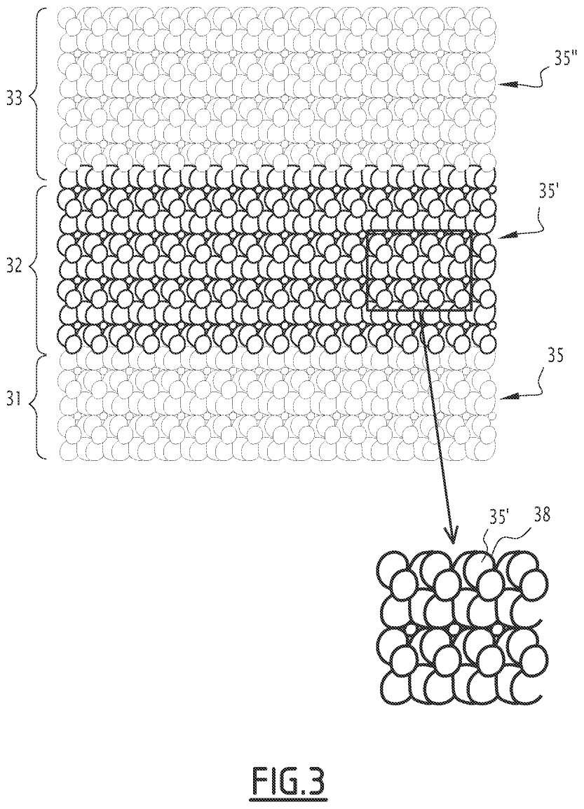

With respect to FIG. 3, it is understood that such a coating can be present as well on the particles (35′) and/or (35″)

### Examples

Tables 4A and 4B show together the examples according to the invention.

TABLE 4A

| | molar composition of the | Atomic composition of the | | | | | |
|---|---|---|---|---|---|---|---|
| Example no. | electrolyte | coating | M¹ | X¹ | A | M² | X² |
| Ex1 | (Li₃PS₄)_{0.8}(Lil)_{0.2} | (Li_{3.1}Y_{0.8}Zr_{0.1}Cl_{5.9})_{0.096}(Na_{0.1}Hf_{0.2}O_{0.3}S | Zr | Cl | Na | Hf | Br |
| | | _{0.4}N_{0.5}Br_{0.6})_{0.005} | | | | | |
| Ex2 | (Li₃PS₄)_{0.8}(Lil)_{0.2} | (Li_{3.2}Y₁Hf_{0.1}Cl_{6.6})_{0.092} | Hf | Cl | — | — | — |
| Ex3 | (Li₃PS₄)_{0.8}(Lil)_{0.2} | (Li_{2.9}Y₁Si0Br_{5.9})_{0.102} | Si | Br | — | — | — |
| Ex4 | (Li₃PS₄)_{0.8}(Lil)_{0.2} | (Li_{3.5}Y₁B0I_{6.5})_{0.091} | B | I | — | — | — |
| Ex5 | Li₃PS₄ | (Li_{3.1}Y_{0.6}Mg_{0.4}Cl_{5.7})_{0.102} | Mg | Cl | — | — | — |
| Ex6 | Li₃PS₄ | (Li_{3.2}Y_{0.8}Ca_{0.2}Cl₆)_{0.098} | Ca | Cl | — | — | — |
| Ex7 | Li₃PS₄ | (Li_{3.1}Y_{0.9}ZR_{0.1}F_{6.2})_{0.097} | Zr | F | — | — | — |
| Ex8 | Li₃PS₄ | (Li₃Y₁Cl₆)_{0.1} | — | Cl | — | — | — |
| Ex9 | Li₃PS₄ | (Li₃Y₁ | — | Cl | Na | Si | CI |
| | | Cl₆)_{0.095}(Na_{0.375}Si_{0.125}O_{0.375}Cl_{0.125})_{0.005} | | | | | |
| Ex10 | (Li₃PS₄)_{0.8}(Lil)_{0.2} | (Li₃Y₁I₆)_{0.09}(Li_{0.061}Si_{0.303}O_{0.636})_{0.01} | — | I | Li | Si | — |
| Ex11 | (Li₃PS₄)_{0.8}(Lil)_{0.2} | (Li₃Y₁Cl₆)_{0.005}(Li_{0.375}P_{0.125}O_{0.5})_{0.095} | — | Cl | Li | P | — |
| Ex12 | (Li₃PS₄)_{0.8}(Lil)_{0.2} | (Li₃Y₁ Bᵣ₆)_{0.09}(Li_{0.167}Si_{0.167}O_{0.333}S_{0.333} | — | Br | Li | Si | — |
| | | )_{0.01} | | | | | |
| Ex13 | Li₆PS₅Cl | (Li₃Y₁Br₆)_{0.03}(K_{0.333}ZR_{0.167}O_{0.5})_{0.07} | — | Br | K | Zr | — |
| Ex14 | Li₆PS₅Cl I | (Li₃Y₁Cl₆)_{0.02}(Ti_{0.333}O_{0.667})_{0.08} | — | Cl | — | Ti | — |
| Ex15 | Li₆PS₅Cl | (Li₃Y₁Br₆)_{0.05}(Li_{0.2}Si_{0.2}O_{0.4}Br_{0.2})_{0.05} | — | Br | Li | Si | Br |
| Ex16 | Li₆PS₅Cl | (Li₃Y₁I₆)_{0.03}(Li_{0.429}P_{0.129}O_{0.4}N_{0.043})_{0.07} | — | I | Li | P | — |
| Ex17 | Li₆PS₅Cl | (Li₃Y₁Cl₆)_{0.07}(Li_{0.429}B_{0.143}O_{0.429})_{0.03} | — | Cl | Li | B | — |
| Ex18 | Li₆PS₅Cl | (Li₃Y₁Cl₆)_{0.05}(Li_{0.2}NB_{0.2}O_{0.6})_{0.05} | — | Cl | Li | Nb | — |
| Ex19 | Li₆PS₅Cl | (Li₃Y₁Cl₆)_{0.03}(Li_{0.375}P_{0.125}O_{0.5})_{0.07} | — | Cl | Li | P | — |

TABLE 4B

| | | | | | | | | | | | | | % | | | |
|---|---|---|---|---|---|---|---|---|---|---|---|---|---|---|---|---|
| | | | | | | | | | | | | | halogen | coating | | Leakage |
| Example | | | | | | | | | | | | | among | thickness | | current |
| no. | a | b | c | n | d | u | v | w | y | z | t | x | anions | (nm) | H2S (cc/g) | (μA/cm²) |
| Ex1 | 0.1 | - 0.2 | 0.1 | 4 | -0.1 | 0.1 | 0.2 | 0.3 | 0.4 | 0.5 | 0.6 | 0 | 99% | 100 | <0.4 | <0.1 |
| Ex2 | 0.2 | 0 | 0.1 | 4 | 0.6 | 0 | 0 | 0 | 0 | 0 | 0 | 0 | 100% | 50 | <0.4 | <0.1 |
| Ex3 | -0.1 | 0 | 0 | 4 | -0.1 | 0 | 0 | 0 | 0 | 0 | 0 | 0 | 100% | 10 | <0.4 | <0.1 |
| Ex4 | 0.5 | 0 | 0 | 3 | 0.5 | 0 | 0 | 0 | 0 | 0 | 0 | 0 | 100% | 5 | <0.4 | <0.1 |
| Ex5 | 0.1 | -0.4 | 0.4 | 2 | -0.3 | 0 | 0 | 0 | 0 | 0 | 0 | 0 | 100% | 5 | <0.4 | <0.1 |
| Ex6 | 0.2 | -0.2 | 0.2 | 2 | 0 | 0 | 0 | 0 | 0 | 0 | 0 | 0 | 100% | 20 | <0.4 | <0.1 |
| Ex7 | 0.1 | -0.1 | 0.1 | 4 | 0.2 | 0 | 0 | 0 | 0 | 0 | 0 | 0 | 100% | 20 | <0.4 | <0.1 |
| Ex8 | 0 | 0 | 0 | | 0 | 0 | 0 | 0 | 0 | 0 | 0 | 0 | 100% | 20 | <0.4 | <0.1 |
| Ex9 | 0 | 0 | 0 | | 0 | 0.4 | 0.1 | 0.4 | 0 | 0 | 0.1 | 0 | 100% | 20 | <0.4 | <0.1 |
| Ex10 | 0 | 0 | 0 | | 0 | 0.1 | 0.3 | 0.6 | 0 | 0 | 0 | 0 | 99% | 20 | <0.4 | <0.1 |
| Ex11 | 0 | 0 | 0 | | 0 | 0.4 | 0.1 | 0.5 | 0 | 0 | 0 | 0.1 | 39% | 20 | <0.4 | <0.1 |
| Ex12 | 0 | 0 | 0 | | 0 | 0.2 | 0.2 | 0.3 | 0.3 | 0 | 0 | 0 | 99% | 20 | <0.4 | <0.1 |
| Ex13 | 0 | 0 | 0 | | 0 | 0.3 | 0.2 | 0.5 | 0 | 0 | 0 | 0.1 | 84% | 20 | <0.4 | <0.1 |
| Ex14 | 0 | 0 | 0 | | 0 | 0 | 0.3 | 0.7 | 0 | 0 | 0 | 0.1 | 69% | 20 | <0.4 | <0.1 |
| Ex15 | 0 | 0 | 0 | | 0 | 0.2 | 0.2 | 0.4 | 0 | 0 | 0.2 | 0.1 | 94% | 20 | <0.4 | <0.1 |
| Ex16 | 0 | 0 | 0 | | 0 | 0.4 | 0.1 | 0.4 | 0 | 0 | | 0.1 | 86% | 20 | <0.4 | <0.1 |
| Ex17 | 0 | 0 | 0 | | 0 | 0.4 | 0.1 | 0.4 | 0 | 0 | 0 | 0 | 97% | 20 | <0.4 | <0.1 |
| Ex18 | | | | | | 0.2 | 0.2 | 0.6 | | | | 0.1 | 91% | 20 | <0.4 | <0.1 |
| Ex19 | 0 | 0 | 0 | | 0 | 0.4 | 0.1 | 0.5 | 0 | 0 | 0 | 0.1 | 84% | 20 | <0.4 | <0.1 |

Table 5 shows a collection of counter-examples (CE).

TABLE 5

| | | | | Leakage |
|---|---|---|---|---|
| Example | composition of | Atomic composition | H₂S | current |
| no. | the electrolyte | of the coating | (cc/g) | (μA/cm²) |
| CE1 | (Li₃PS₄)_{0.8}(LiI)_{0.2} | without coating | 3 | <1 |
| CE2 | (Li₃PS₄)_{0.8}(LiI)_{0.3} | (Al₂O₃)_{0.2} | <0.4 | >1 |
| CE3 | (Li₃PS₄)_{0.8}(LiI)_{0.4} | (SiO₂)_{0.33} | <0.4 | >1 |

The coating for producing examples is performed by magnetron sputtering of the compound to be deposited on the electrolyte powder, the latter being placed in motion on a fluidized bed or in a rotating drum.

### Preparation of Electrolyte Materials:

Electrolyte powders are prepared by mechanosynthesis. The precursors used are powders of Li₂S, P₂S₅, LiCl and LiI. The precursors as well as the beads are introduced in stoichiometric quantities into a sealed jar in a glove box under argon. The jars are then placed in a Fritsch Pulverisette® P7 planetary grinder. The mixture is ground for 24h at a speed of 800 rpm.

### Preparation of the Materials Used for the Coating:

Powders of the mixture to be deposited on the surface of the electrolyte particles are prepared by the same mechanosynthesis method as hereinabove. The precursors used are the halides or oxides of the cations forming the material to be deposited: i.e. for the examples shown in Table 1: LiCl, LiBr, LiI, LiF, YCl₃, YF₃, YBr₃, ZrCl₄, SiCl₄, HfCl₄, NaCl, MgCl₂, CaCl₂, Li₂O, K₂O, SiO₂, P₂O₅, B₂O₃, Nb₂O₅, ZrO₂, TiO₂. The stoichiometric mixture is ground under conditions similar to those of the electrolyte, i.e. 24h at 800 rpm.

### Producing the Powder Coating:

The powder of the mixture to be deposited is compressed in a pellet mill at 3t/cm² in order to produce a target which would subsequently be used for the deposition by magnetron sputtering.

The system for producing the coating consists in placing in the sputtering enclosure, a chamber which allows movements of rotation and vibration to be generated. The electrolyte powder is placed in the chamber which allows a homogeneous coating of the compound to be coated. The deposition conditions are adapted from the conditions described by Fernandes et al., Surface and coatings technology 176 (2003), 103-108.

Deposition times vary depending on the coating compounds and on the desired thickness.

Thickness can be measured by transmission microscopy.

### Measurement of H₂S Generation by the Coated Electrolyte Powder in a Humid Atmosphere:

In order to measure the release of H₂S, 25 mg of powder were inserted into a 2.5 l container which could be hermetically sealed and wherein a H₂S detector (1 ppm accuracy) was placed. In the present example, the container contained ambient air at atmospheric pressure and ambient temperature, so as to assess the risk associated with the release of H₂S under standard conditions under which the materials could be found. Moreover, the previous system contained a beaker containing acidified water the function of which was to maintain humidity in the air throughout the reaction between the electrolyte powder and the water in gaseous form. The H₂S concentration in the chamber was recorded at regular intervals as soon as the sample was inserted and was expressed in cc of H₂S formed by gram of electrolyte.

The value shown in Tables 1 and 2 is the concentration of H₂S measured after 30 minutes.

### Measurement of the Leakage Current:

A quantity of coated electrolyte powder of about 1 Omg was inserted into a cell similar to a pellet mold with a 7 mm diameter, the pistons of which were made of stainless steel and the body of insulating material not reacting chemically with the electrolyte or electrode materials. The powder was thus compressed under a pressure of 4 t/cm². A lithium disk was then inserted between a piston and the previously obtained pellet; the assembly was then compressed in the cell under a pressure of 0.1 t/cm².

The cell thus obtained was placed in a sealed enclosure ensuring the absence of any trace of moisture during the test.

The cell was heated at 60° C. for two weeks. Such treatment accelerated the possible reactions between the electrolyte and the lithium metal.

After treatment, a voltage of 2V as applied to the terminals of the cell and the current was recorded. The current decreased rapidly with time and then stabilized. The leakage current corresponded to the value of the current after stabilization, typically after 24h and was expressed per cm² of electrode.

The results are shown in Tables 1 and 2.

The counter-examples described in Table 5 show that the coating significantly reduces the amount of H₂S, but the leakage current is >1 μA/cm².

Heat treatment at 60° C. leads to reducing the coating compound. In fact, SiO₂ and Al₂O₃ are not stable at the potential of lithium metal. Conducting metal compounds are then formed at the surface of the electrolyte particles, which no longer allows the electrolytic layer to provide electronic insulation. A significant self-discharge of the cell results therefrom, making such technology unsuitable for many applications.

On the other hand, the examples of the invention described in Tables 3A and 4B make it possible to achieve low values of H₂S generated in a humid atmosphere while maintaining a low leakage current, which makes it possible to obtain a low self-discharge battery.

1. An electrode which can be used in an energy storage device comprising at least one active material and at least one carbon-containing electronic material, said electrode being covered, on all or part of its surface thereof, with a coating layer made of a electronic insulator and ionic conductor material, said electrode being such that A1<6 and A2>10,
with:
$$A 1 = ln ( \frac{e}{σ i \times S ( mat . act . )} )$$
$$A 2 = ln ( \frac{e}{σ e \times S ( cond . )} )$$
where:
e represents the thickness of the coating layer (in m),
σi represents the ionic conductivity, measured at 25° C., of the electronic insulator and ionic conductor material (in S·m⁻¹),
S(mat. act) represents the ratio between the surface area developed by the active material and the total surface area of the electrode (in m² of active material per cm² of electrode),
σe represents the electronic conductivity, measured at 25° C., of the electronic insulator and ionic conductor material (in S·m⁻¹), and
S(cond.) represents the ratio between the surface area developed by the active material and by the electronic carbon material and the total surface area of the electrode (in m² per cm² of electrode).

2. The electrode according to claim 1, wherein the electronic insulator and ionic conductor material has an electron conductivity, measured at 25° C., of less than or equal to 10⁻¹⁰ S·m⁻¹, preferentially less than or equal to 10⁻¹² S·m⁻¹.

3. The electrode according to claim 1, wherein the electronic insulator and ionic conductor material has an ion conductivity, measured at 25° C., greater than or equal to 10⁻⁸ S·m⁻¹, preferentially greater than or equal to 10⁻⁶ S·m⁻¹.

4. The electrode according to claim 1, wherein the electronic insulator and ionic conductor material is selected from halides, oxides, phosphates, sulfides, polymers and any mixture thereof.

5. The electrode according to claim 1, wherein the thickness of the coating layer ranges from 2 to 50 nm, preferentially from 5 to 10 nm.

6. The electrode according to claim 1, wherein the coating layer covers at least 50% of the surface of the electrode, preferentially at least 75%, more preferentially at least 90%, even more preferentially at least 95%.

7. The electrode according to claim 1, wherein the electrode coated with the coating layer is porous and at least part of the pores of the coated electrode is at least partially filled with a solid electrolytic material, preferentially a solid electrolyte sulfur material.

8. A method for manufacturing an electrode according to claim 1, comprising:
a) the supply of an electrode,
b) the deposition on all or part of the surface of the electrode, of a coating layer as defined in claim 1,
c) optionally, the deposition by infiltration into at least part of the pores of the coating layer, of a solid electrolytic material, preferentially a solid electrolyte sulfur material, and
d) optionally, a treatment enabling the electrolyte to solidify, in particular by heat treatment or by ultraviolet radiation.

9. An electrochemical cell comprising a stack between two electronic conductor current collectors, said stack comprising:
a positive electrode;
a negative electrode;
a layer comprising a solid electrolytic composition separating said positive electrode and said negative electrode, the electrolytic composition comprising at least one solid electrolytic compound, preferentially selected from solid electrolyte sulfur compounds and polymers;
said element being characterized in that at least one amongst said positive electrode and said negative electrode is as defined in claim 1.

10. An element according to claim 9, wherein both said positive electrode and said negative electrode are covered, on all or part of the surface thereof, with a coating layer, either identical or different, as defined in claim 1.

11. (canceled)

12. Electrolyte particles configured to be used in an electrochemical cell, comprising of solid electrolyte sulfide particles coated with a layer comprising an ionic conducting inorganic material comprising a halogen.

13. The solid electrolyte particles according to claim 12, wherein said coating material has the formula (I):
Li₃₊ₐY_{1+b}M_{c}X_{6+d} (I)
Wherein:
Y represents yttrium;
M is a metal selected from Zr, Hf, Ti, Si, B, Al, Sc, Ga, Ta, Nb, Ca, Mg;
X represents a halogen atom selected from Cl, Br, I, F;
a, b, c and d, which are either identical or different, are numbers the absolute value of which is comprised between 0 and 0.5 (limits included) and such that: a+3xb+nxc=d;
n is an integer equal to 2, 3, 4 or 5, depending on the nature of M:
n=2 for Ca, Mg; n=3 for B, Al, Sc, Ga; n=4 for Si, Zr, Ti, Hf and n=5 for Nb, Ta.

14. The solid electrolyte particles according to claim 12, wherein said coating material has the formula (II)
(Li₃₊ₐY_{1+b}M¹_{c}X¹_{6+d})_{[1/(10+a+b+c+d)-x]}(AᵤM²ᵥO_{w}S_{y}N_{z}X²ₜ) (II)
Wherein:
Y represents yttrium;
M¹ is a metal selected from Zr, Hf, Ti, Si, B, Al, Sc, Ga, Ta, Nb, Ca, Mg;
X¹ and X², which can be the same or different, independently represent a halogen atom selected from Cl, Br, I, F;
a, b, c and d, which are either identical or different, are numbers the absolute value of which is comprised between 0 and 0.5 (limits included) and such that: a+3xb+nxc=d;
n is an integer equal to 2, 3, 4 or 5, depending on the nature of M:
n=2 for Ca, Mg; n=3 for B, Al, Sc, Ga; n=4 for Si, Zr, Ti, Hf and n=5 for Nb, Ta;
A=Li, Na, K, Mg, Ca;
M² is an element selected from Si, B, Al, SC, GA, TA, Nb, P, a transition metal (MT), a rare earth (TR);
u, v, w, x, y, z, t either identical or different are such that:
u+v+w+y+z+t=1;
u: number between 0 and 0.6 (limits included);
v: number between 0.1 and 0.3 (limits included);
w, y, z, t: numbers between 0 and 0.6 (limits included); and
x: number between 0 and 0.3 (limits included).

15. The solid electrolyte particles according to claim 13, such that in the general formula (I) X is Cl or Br or in the general formula (II) X¹ and X², either identical or different, are selected from Cl or Br.

16. The solid electrolyte particles according to claim 13, wherein in the general formula (I), b is equal to 0; c is equal to 0; and d is equal to 0.

17. The solid electrolyte particles according to claim 12, wherein the sulfide type solid electrolyte is selected from:
Li₃PS₄,
all [(Li₂S)_{y}(P₂S₅)_{1-y}]_{(l-z)} (LiX)_{z} (with X representing a halogen element; 0<y<1; 0<z<1) phases;
(Li₃PS₄)_{0.8}(LiI)_{0.2},
argyrodites such as Li₆PS₅X, with X=Cl, Br, I, or Li₇P₃S₁₁,
sulfide electrolytes having the crystallographic structure equivalent similar to the structure of Li₁₀GeP₂S₁₂, and
the mixtures thereof.

18. An all-solid electrochemical cell comprising electrolyte particles according to claim 12.

19. The all-solid electrochemical cell according to claim 18, consisting of a negative electrode layer, a positive electrode layer and an electrolyte layer, such that said electrolyte particles are present within at least one of the three layers.

20. An electrochemical module comprising a stack of at least two elements defined in claim 9 or of at least two elements according to claim 18, each element being electrically connected with one or a plurality of other elements.

21. A battery comprising one or a plurality of modules according to claim 20.
